(19) United States
(12) Patent Application Publication
(10) Pub. No.: US 2012/0120282 A1
(43) Pub. Date: May 17, 2012

(54) Reducing Temporal Aliasing

(76) Inventor: Andrew C. Goris, Loveland, CO (US)

(21) Appl. No.: 13/386,609

(22) PCT Filed: Aug. 14, 2009
(86) PCT No.: PCT/US2009/053930

§ 371 Date: Jan. 23, 2012

(51) Int. Cl. H04N 5/217; H04N 5/265

(52) U.S. Cl. 348/239; 348/E05.056; 348/E05.078

(57) ABSTRACT

Camera systems and methods to reduce temporal aliasing are disclosed. In an exemplary embodiment the method may include selecting exposure times for each frame based on lighting conditions and a frame rate for frame capture. The method may also include capturing a plurality of exposures for each frame based on the selected exposure times. The method may also include integrating the plurality of exposures for each frame.

### BACKGROUND

Digital cameras are widely commercially available, ranging both in price and in operation from sophisticated cameras used by professionals to inexpensive “point-and-shoot” cameras that nearly anyone can use with relative ease. Unlike conventional film cameras, digital cameras include image capture electronics that convert light (or photons) into electrical charge. The electrical charge accumulated on each photo-cell (or pixel) is read out and used to generate a digital image of the scene being photographed.

When capturing images in bright light, the amount of light reaching the image sensor needs to be reduced so that the image sensor does not saturate (resulting in a washed out image). Reducing the amount of light reaching the image sensor is of particular concern during long exposure times, such as the typical exposure times for video capture.

An aperture or neutral density filter may be used to reduce the amount of light reaching the image sensor. However, in small camera modules, such as those used in camera phones, it is not desirable to use an aperture or neutral density filter to control brightness due to cost, physical size, and the resulting diffraction degradation.

Without an aperture or neutral density filter, the shutter time can be made very fast (e.g., 1/1000 second). However, this produces a “jerky” appearance in the resulting video. This effect, also referred to as “temporal aliasing,” is similar to the what makes wheel spokes appear to spin backwards in video.

### BRIEF DESCRIPTION OF THE DRAWINGS

FIG. 1 is a high-level diagram of an exemplary camera system which may be implemented to reduce temporal aliasing.

FIG. 2 is a timeline illustrating exemplary frame capture to reduce temporal aliasing.

FIG. 3 is a sensor illustrating exemplary frame capture to reduce temporal aliasing.

FIG. 4 are video frames illustrating exemplary frame capture to reduce temporal aliasing.

FIG. 5 is a flowchart illustrating exemplary operations which may be implemented to reduce temporal aliasing.

### DETAILED DESCRIPTION

Briefly, camera systems and methods may be implemented to reduce temporal aliasing in digital video or still pictures. The systems and methods described herein may be implemented in a digital video camera, digital still camera, or other image capture device.

In an exemplary embodiment, a camera system may include an electronic shutter configured to control exposure time of a sensor. Exposure control logic may be stored on computer-readable storage and executable to reduce temporal aliasing. The logic may signal the electronic shutter to capture a plurality of exposures for each frame. The logic may also integrate the plurality of exposures for each frame. The exposure control logic may also select exposure times for each frame based on lighting conditions during frame capture. The exposure control logic may also select exposure times for each frame based on frame rate for frame capture.

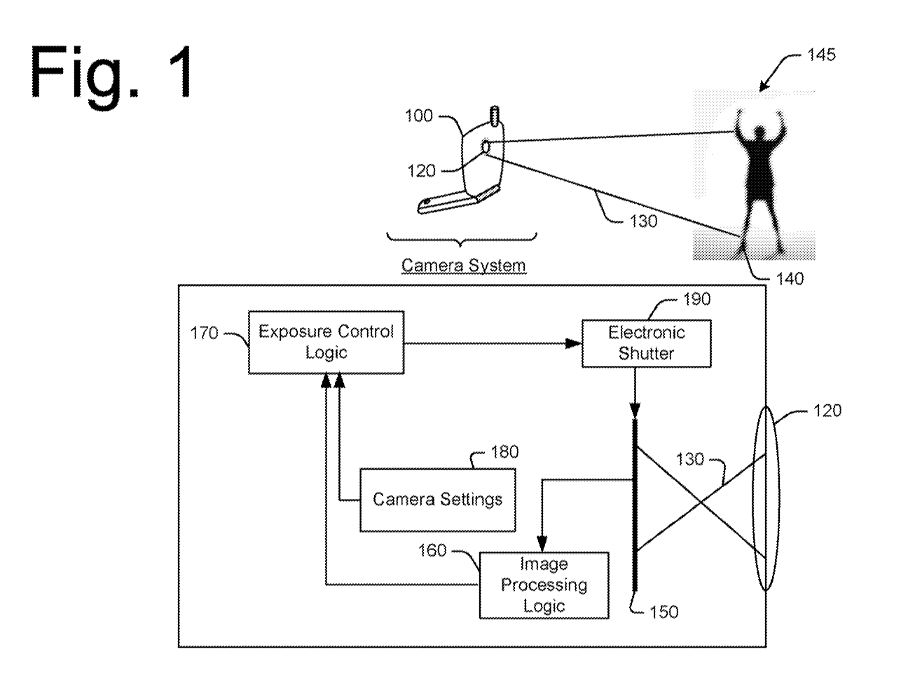

FIG. 1 is a high-level diagram of an exemplary camera system 100 which may be implemented to reduce temporal aliasing. In an exemplary embodiment, the camera system 100 may include digital video cameras, although the systems and methods described herein are not limited to digital video cameras and may also be implemented with digital still-photo cameras. In addition, the camera system 100 may include a digital video camera implemented in a camera phone, although the camera system 100 is not limited to use in camera phones and may be any suitable camera system now known or that may be later developed.

Exemplary camera system 100 may include a lens 120 positioned in the camera system 100 to focus light 130 reflected from one or more objects 140 in a scene 145 onto an image sensor 150 (e.g., for image exposure). Exemplary lens 120 may be any suitable lens which focuses light 130 reflected from the scene 145 onto image sensor 150.

Exemplary image sensor 150 may be implemented as a plurality of photosensitive cells, each of which builds-up or accumulates an electrical charge in response to exposure to light. The accumulated electrical charge for any given pixel is proportional to the intensity and duration of the light exposure. Exemplary image sensor 150 may include, but is not limited to, a charge-coupled device (CCD), or a complementary metal oxide semiconductor (CMOS) sensor.

Internal components of the camera system 100 are shown in the block diagram in FIG. 1. The image sensor 150 is provided with an electronic shutter controller 190 (also referred to as a “global electronic shutter”). During use, the electronic shutter controller resets the entire sensor 150 before image capture. Then the pixels accumulate charge for some period of time (the exposure time). When light collection ends, all charges are transferred to light shielded areas of the sensor. The light shield prevents further accumulation of charge during the readout process. The charges are then shifted out of the light shielded areas of the sensor and read out.

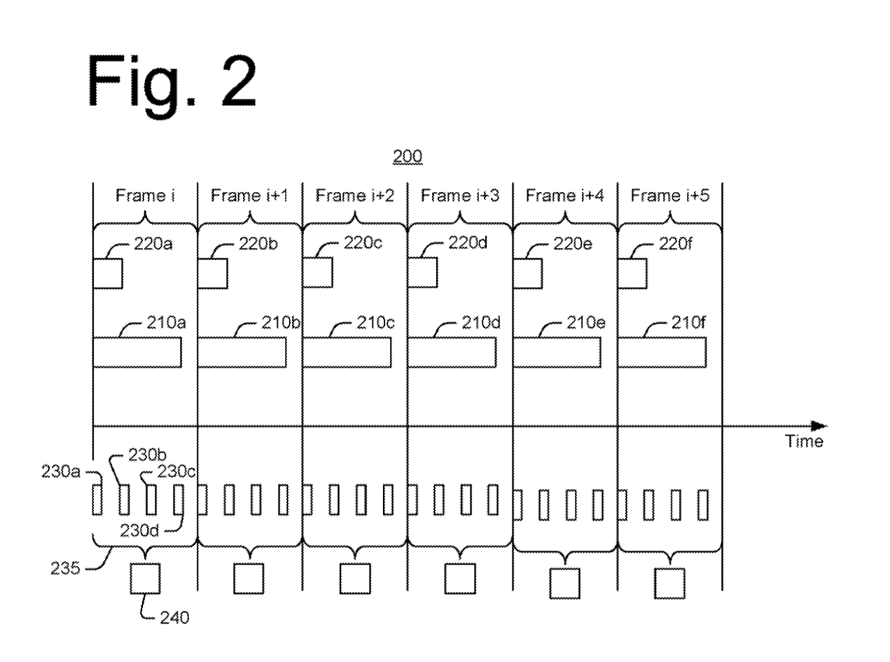

In an exemplary embodiment, the total exposure time may be further divided into a plurality of exposures for each frame, as will be explained in more detail below with reference to FIGS. 2-4. For now it is enough to understand that the electronic shutter controller 190 may operate the sensor 150 to start collecting light, then stop collecting light without resetting the sensor, then collect light on the sensor, and so forth in order to collect a plurality of exposures during each frame.

Camera system 100 may also include image processing logic 160. In digital cameras, the image processing logic 160 receives electrical signals from the image sensor 150 representative of the light 130 captured by the image sensor 150 during exposure to generate a digital image of the scene 145.

Image sensors, and image processing logic, such as those illustrated in FIG. 1, are well-understood in the camera arts. These components may be readily provided for camera system 100 by those having ordinary skill in the art after becoming familiar with the teachings herein, and therefore further description is not necessary.

Camera system 100 may also include exposure control logic 170. Exposure control logic 170 may be operatively associated with the electronic shutter and sensor for exposure control operations as briefly explained above and explained in more detail below with reference to FIG. 2. During image capture operations, exposure control logic 170 receives input from the sensor or other light sensor (e.g., via image processing logic 160), and/or the user via a user interface and/or camera settings module 180. Exposure control logic 170 characterizes the light in the scene to determine exposure times including the number of exposures per frame, and the timing and spacing of each of the individual exposures within the frame. Too much light may wash out the image.

In addition to characterizing the lighting for a scene, other factors may also be considered for determining the exposure times. For example, camera settings module 180 may include factory-configured and/or user-configured settings for the camera system 100. Exemplary factors may include, but are not limited to, user preferences (e.g., the desired image sharpness, special effects, etc.), camera mode, other lighting conditions (indoors versus outdoors), operational mode (e.g., focal length), etc.

It is noted that the number of exposures within each frame and the time of each exposure will depend at least to some extent on one or more design considerations, such as, e.g., lighting conditions, user preferences, etc.

If the determination is made to capture a plurality of exposures within one or more individual frame of the video, the exposure control logic 170 may cooperate with the sensor 180 during at least a portion of the exposure time. In exemplary embodiments, the exposure control logic 170 instructs the electronic shutter to modulate the sensor 150 during video capture.

In an exemplary embodiment, the exposure control logic 170 generates one or more signals for the electronic shutter. The signal(s) indicate the number of exposures and exposure times for each frame. The signal(s) may also specify exposure spacing within each frame. The signal(s) may indicate both which frames include multiple exposures and the specific properties of each of the multiple exposures. Exemplary implementation may be better understood with reference to FIGS. 2-4.

Before continuing, however, it is noted that the camera system 100 shown and described above with reference to FIG. 1 is merely exemplary of a camera system which may be implemented to reduce temporal aliasing in digital video. The embodiments described herein are not intended to be limited only to use with the camera system 100. Other cameras are also contemplated which may be implemented to reduce temporal aliasing in digital video.

FIG. 2 is a timeline 200 illustrating exemplary video capture to reduce temporal aliasing. Frames (Frame i, Frame i+1, etc.) are indicated between the vertical lines shown in FIG. 2 and occur over regular intervals. The frames may be generated at a predetermined frame rate. For example, a common frame rate is 30 frames per second. Other common frame rates may be 24, 48, or 60 frames per second, although any frame rate may be used.

During normal video capture, the exposure time may equal or nearly equal the time for each frame, as illustrated by blocks 210a-f in each frame. When lighting in the scene is too bright (e.g., such that the light would saturate the sensor), the exposure time may be reduced. Reduced exposure times (e.g., 1/1000 seconds) are illustrated in FIG. 2 by blocks 220a-f. However, simply reducing the exposure time may result in a video that appears “jerky” or “choppy.” This effect is also known as temporal aliasing.

The embodiments described herein implement a shortened exposure time. Indeed, it is possible to use the same shortened exposure time (e.g., 1/1000 seconds). But then the exposure time is further subdivided into a plurality of exposures for each frame, as illustrated in FIG. 2 by blocks 230a-d. Capturing a plurality of exposures may be accomplished by electronically starting and stopping the exposure, without resetting the sensor until after the last exposure (230d) is captured. The sensor can then be reset and the process repeated for each frame.

The plurality of exposures 230a-d can then be combined (integrated, averaged, or otherwise transformed using a suitable mathematical function) as indicated by brackets 235 in FIG. 2 to obtain image data for each frame. Image data for the first frame from combining the plurality of exposures 230a-d are illustrated by block 240. By capturing a plurality of exposures for each frame, the shortened exposure time is spread out over each frame. After combining, the final image data for each frame will be a smoother representation of the original moving scene.

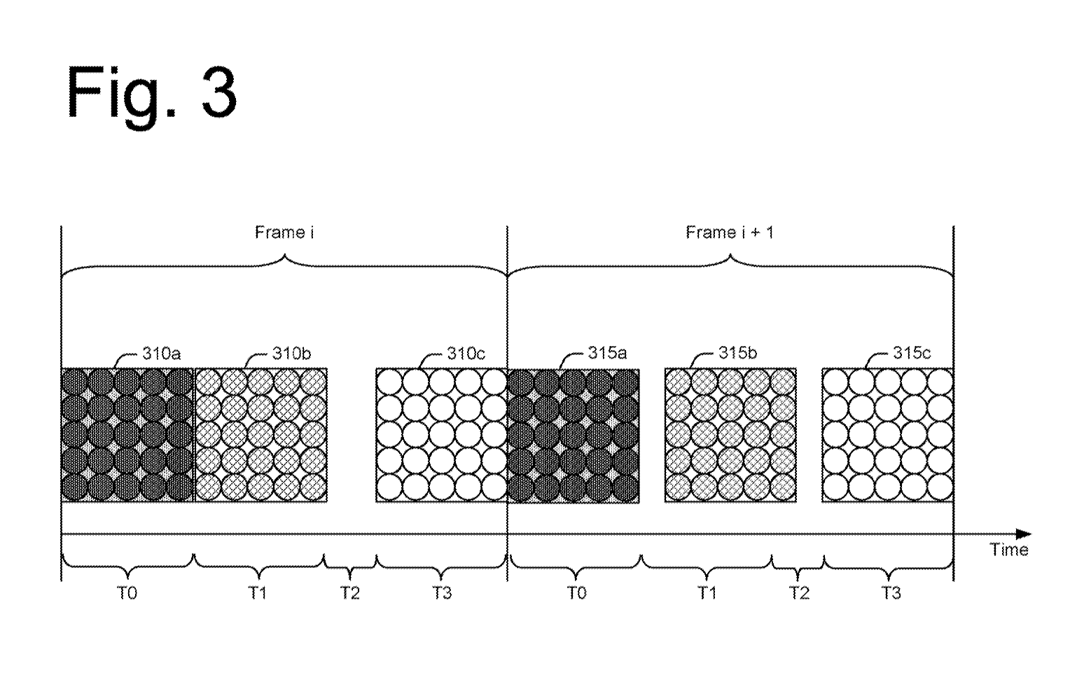

FIG. 3 is a sensor illustrating exemplary video capture to reduce temporal aliasing. During video capture, the electronic shutter controller may reset the entire sensor before image capture for each frame, as indicated by sensor pixels 310a for Frame i in FIG. 3.

The electronic shutter controller may operate the sensor to start collecting light. The pixels accumulate charge for an exposure time (T1), as indicated by sensor pixels 310b for Frame i in FIG. 3. The electronic shutter controller may operate the sensor to stop collecting light without resetting the sensor for some period of time (T2). Then the electronic shutter controller may operate the sensor to again collect light for an exposure time (T3), as indicated by sensor pixels 310c. The process is shown repeating, and accumulating charges for sensor pixels 315a-c. Although only two exposure times T1 and T3 are shown for Frame i in FIG. 3, this process may continue for any suitable number of exposure times for each frame.

When light collection ends, the charges are then read out through standard means. The sensor may be reset (time T0 for Frame i+1), and the process may repeat for the second frame (Frame i+1) and so forth for each frame.

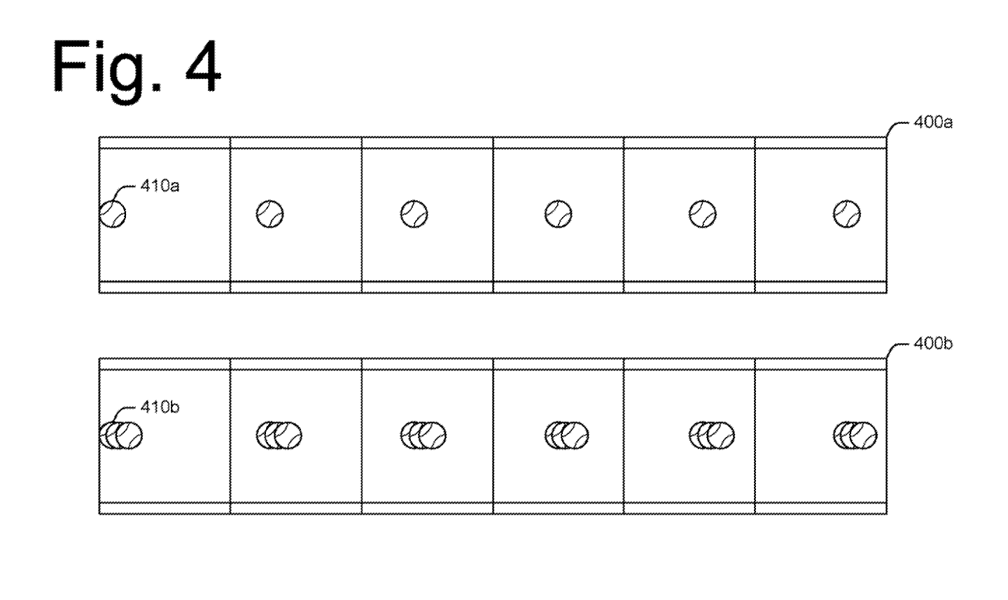

FIG. 4 are video frames 400a and 400b illustrating exemplary video capture to reduce temporal aliasing. Simply reducing exposure times may result in a video that appears “jerky” or “choppy,” as illustrated by the moving ball 410a in video frames 400a.

In order to reduce such temporal aliasing, exposure times may be shortened and each exposure further subdivided into a plurality of exposures, as explained above with reference to FIGS. 2 and 3. Accordingly, a plurality of exposures may be captured and integrated or otherwise combined. Integrating the plurality of exposures for each frame blurs the motion, and thereby smoothes appearance of motion (e.g., of the ball) in the resulting video, as illustrated by the moving ball 410b in video frames 400b.

Before continuing, it is noted that examples described above with reference to FIGS. 2-4 are provided only for purposes of illustration and are not intended to be limiting. In addition, the examples discussed above may be based on real-time input and/or at least in part on static input (e.g., factory settings and/or user selections).

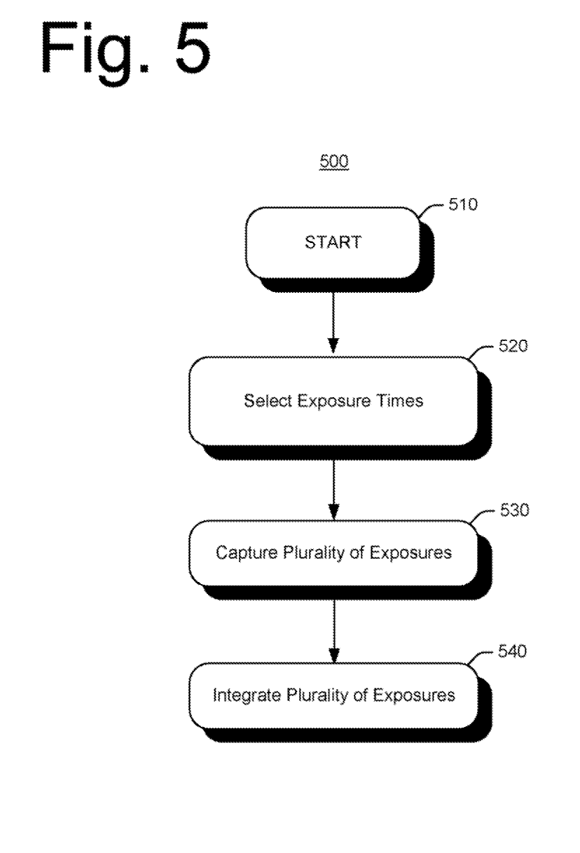

FIG. 5 is a flowchart illustrating exemplary operations which may be implemented to reduce temporal aliasing. Operations 500 may be embodied as logic instructions on one or more computer-readable medium in the camera system. When executed on a processor at the camera system, the logic instructions implement the described operations. In an exemplary embodiment, the components and connections depicted in the figures may be used.

The process may be started in operation 510. In an exemplary embodiment, the process starts automatically based on ambient lighting conditions of the scene as determined based on feedback from the camera sensor (and/or other light sensor). The process may also be started manually, e.g., based on user evaluation of the lighting conditions and/or the desire for special effects. Other factors, such as focal length of the camera may also be considered.

It is noted that the anti-aliasing process may also be deactivated automatically or manually by the user so that the process does not start in operation 510. For example, it may be desirable to deactivate anti-aliasing if the user is capturing video under controlled lighting conditions, or where special effects are desired. In an exemplary embodiment, the process may be automatically deactivated, e.g., based on input from a light sensor.

In operation 520, exposure times are selected for each frame based on lighting conditions and a frame rate for video capture. It is noted that the time for capturing the plurality of exposures for each frame is less than the time for each frame, and the total exposure time for capturing the plurality of exposures for each frame is selected to prevent light saturation.

Exposure times may be utilized to control exposure during image capture. In operation 530, a plurality of exposures may be captured for each frame based on the exposure times. In an exemplary embodiment, the electronic shutter modulates the sensor to collect light on the sensor. For example, the electronic shutter may start collecting light on the sensor, then stop collecting light without resetting the sensor, then collect light on the sensor, and so forth during the entire frame. For example, the exposure control logic may generate a signal for controlling one or more optical elements during exposure. It is noted that the lighting conditions may not warrant any change to the exposure times, and therefore, a signal may not be issued (or a null signal may be issued).

It is noted that each of the plurality of exposures may have equal or unequal exposure times. Alternatively, at least some of the plurality of exposures may have unequal exposure times. In addition, each of the plurality of exposures may be equally spaced throughout the frame. Alternatively, at least some of the plurality of exposures may be unequally spaced throughout the frame.

In operation 540, the plurality of exposures are integrated for each frame. Integrating the plurality of exposures for each frame blurs and thereby smoothes appearance of motion in the resulting video.

The operations shown and described herein are provided to illustrate exemplary embodiments to reduce temporal aliasing. It is noted that the operations are not limited to the ordering shown. In addition, operations may be repeated or deferred based on input from the user and/or environmental conditions. In addition, operations may terminate and/or restart at any point in time, e.g., if the user focuses the camera on a different scene, or if an earlier characterization of the scene has otherwise become invalid.

In addition to the specific embodiments explicitly set forth herein, other aspects and embodiments will be apparent to those skilled in the art from consideration of the specification disclosed herein. It is intended that the specification and illustrated embodiments be considered as examples only.

1. A method to reduce temporal aliasing in video or still pictures, comprising:
selecting exposure times for each frame based on lighting conditions and a frame rate for frame capture;
capturing a plurality of exposures for each frame based on the selected exposure times; and
integrating the plurality of exposures for each frame.

2. The method of claim 1 further comprising signaling an electronic shutter to capture the plurality of exposures for each frame on a sensor.

3. The method of claim. 2 further comprising modulating the sensor to collect light during capturing of the plurality of exposures for each frame.

4. A camera system comprising:
an electronic shutter configured to control exposure time of a sensor;
exposure control logic stored on computer-readable storage and executable to reduce temporal aliasing or still frames by:
signaling the electronic shutter to capture a plurality of exposures for each frame; and
integrating the plurality of exposures for each frame.

5. The camera system of claim 4 wherein the exposure control logic selects exposure times for each frame based on lighting conditions during frame capture.

6. The camera system of claim 4 wherein the exposure control logic selects exposure times for each frame based on frame rate for frame capture.

7. The camera system of claim 4 wherein the electronic shutter is programmable by the exposure control logic.

8. The camera system of claim 4 wherein the electronic shutter modulates the sensor to collect light on the sensor, stop collecting light without resetting the sensor, and then collect light on the sensor.

9. The method of claim 1 or the camera system of claim 4, wherein time for capturing the plurality of exposures for each frame is less than time for each frame.

10. The method of claim 1 or the camera system of claim 4, wherein total exposure time for capturing the plurality of exposures for each frame is selected to prevent light saturation.

11. The method of claim 1 or the camera system of claim 4, wherein each of the plurality of exposures have equal exposure times.

12. The method of claim 1 or the camera system of claim 4, wherein at least some of the plurality of exposures have unequal exposure times.

13. The method of claim 1 or the camera system of claim 4, wherein each of the plurality of exposures are equally spaced throughout the frame.

14. The method of claim 1 or the camera system of claim 4, wherein at least some of the plurality of exposures are unequally spaced throughout the frame.

15. The method of claim 1 or the camera system of claim 4, wherein integrating plurality of exposures for each frame smoothes appearance of motion.
